(19) United States
(12) Patent Application Publication
(10) Pub. No.: US 2021/0053806 A1
(43) Pub. Date: Feb. 25, 2021

(54) OVERLOAD PROTECTION MECHANISM FOR WINCH

(71) Applicant: REXON INDUSTRIAL CORP., LTD., Taichung (TW)

(72) Inventor: Wan Jie YOU, Taichung (TW)

(73) Assignee: REXON INDUSTRIAL CORP., LTD., Taichung (TW)

(21) Appl. No.: 16/998,023

(22) Filed: Aug. 20, 2020

(30) Foreign Application Priority Data
Aug. 21, 2019 (TW) 108129864

(51) Int. Cl. B66D 1/58; F16D 7/04

(52) U.S. Cl. CPC B66D 1/58; F16D 2121/14; F16D 7/044

(57) ABSTRACT

An overload protection mechanism for a winch that includes an input transmission shaft, an output transmission shaft, and a clutch mechanism. The input transmission shaft has a first transmission end, the output transmission shaft has a second transmission end. The clutch mechanism has a first clutch member disposed on the first transmission end and a second clutch member disposed on the second transmission end such that the first and second clutch members are correspondingly rotatable with the input transmission shaft and the output transmission shaft. The first and second clutch members are detachably engageable with each other. When the output transmission shaft is overloaded, the first and second clutch members are disengaged for preventing the overloaded power transmission between input transmission shaft and output transmission shaft.

### TECHNICAL FIELD

The present invention is related to a winch, and particularly to an overload protection mechanism for the winch.

### BACKGROUND OF THE INVENTION

A winch is a mechanical device that uses the rotation of the spool to wind or release ropes, such as, steel ropes. After the winding of the cable is completed, if the power source continues to output power to the transmission shaft installed in the spool, the transmission shaft is likely to be damaged. In order to avoid this situation, an overload protection mechanism is usually set inside the winch to protect the transmission shaft, so that the transmission shaft can release the power transmission with the power source when the load is too large.

The prior art teaches that the overload protection mechanism, as disclosed in the Republic of China (Taiwan) Patent No. 1622549, mainly relies on the combination of the rolling element and the inner and outer arc grooves to release the power transmission between the input transmission shaft and the transmission ring in the case of excessive load, so that the input transmission shaft cannot transmit power to the output transmission shaft in order to protect the overall structure. This structure, however, can still be improved.

### SUMMARY OF THE INVENTION

One of the purposes of the present invention is to provide an overload protection mechanism for a winch, which has a good overload protection.

In order to achieve such benefit, the overload protection mechanism of the present invention includes an input transmission shaft, an output transmission shaft, and a clutch mechanism. The input transmission shaft and the output transmission shaft coaxially correspond to each other, the input transmission shaft has an input end and a first transmission end, and the output transmission shaft has a second transmission end and an output end. The clutch mechanism has a first clutch member, a second clutch member and an elastic part. The first clutch member is set at the first transmission end of the input transmission shaft, so that the first clutch member can operate synchronously with the input transmission shaft. The second clutch member is set at the second transmission end of the output transmission shaft, so that the second clutch member can operate synchronously with the output transmission shaft. In addition, the first clutch member has a first engaged part, and the second clutch member has a second engaged part. The first engaged part of the first clutch member is detachably engaged in the second engaged part of the second clutch member, and the elastic part acts on the first clutch member to push the first clutch member in the direction of the second clutch member.

In view of such structure, under the condition that the output end of the output transmission shaft is under normal load, the first engaged part of the first clutch member and the second engaged part of the second clutch member are engaged with each other, so that the input transmission shaft can transmit power to the output transmission shaft through the clutch mechanism, and the output transmission shaft can rotate smoothly. Once the output end of the output transmission shaft is overloaded, the first engaged part of the first clutch member and the second engaged part of the second clutch member will be disengaged which cuts off the power transmission between the input transmission shaft and the output transmission shaft, so that the input transmission shaft cannot transmit power to the output transmission shaft, thereby protecting the overall structure.

Preferably, the first engaged part of the first clutch member is one of recesses or bumps. At least one of the first engaged parts is a bump that has two first inclined planes which are inclined in opposite directions and one first plane which connects the two first inclined planes. The second engaged part of the second clutch member is the other one of the recesses or bumps that matches the corresponding recess or bump of the first engaged part. For example, the second engaged part can include a recess that has two second inclined planes which are inclined in opposite directions and one second plane which connects the two second inclined planes. Therefore, when the first engaged part of the first clutch member is engaged with the second engaged part of the second clutch member, the first inclined plane of the first engaged part abuts on the second inclined plane of the second engaged part, and the first plane of the first engaged part abuts on the second plane of the second engaged part. When the output end of the output transmission shaft is overloaded, with the cooperation of the first inclined plane and the second inclined plane, the first engaged part of the first clutch member engaged with the second engaged part of the second clutch member can be quickly and surely disengaged.

Preferably, the outer surface of the first transmission end of the input transmission shaft has an insertion portion. The first clutch member has the first shaft hole. The first clutch member is sleeved on the first transmission end of the input transmission shaft with the first shaft hole. In addition, the wall of the first shaft hole has an insertion slot. The input transmission shaft is engaged in the insertion slot of the first clutch member with the insertion portion of the first transmission end, so that the input transmission shaft is able to drive the first clutch member to rotate them together.

Preferably, the first transmission end of the input transmission shaft has a screw hole and the clutch mechanism also has a screw. The screw passes through a washer and is screwed in the screw hole, so that the washer abuts against the first transmission end of the first clutch member and the input transmission shaft to prevent the first clutch member from falling off.

Preferably, the one side of the first clutch member opposite to the second clutch member has a shaft and a container surrounding the shaft. The elastic part is sleeved, e.g., is set on, the input transmission shaft. The outer circumferential surface of the input transmission shaft has a shoulder between the input end and the first transmission shaft. The clutch mechanism also has a support ring. One side of the support ring abuts the shoulder of the input transmission shaft. The other opposite side of the support ring receives one end of the elastic part. The other end of the elastic part is sleeved on the shaft of the first clutch member and located in the container of the first clutch member, and abuts on the one side of the first clutch member facing the second clutch member, so that the elastic part is able to provide elastic force, e.g., spring force, to push the first clutch member toward the second clutch member.

Preferably, the second clutch member has a second shaft hole. The second clutch member is sleeved on the second transmission end of the output transmission shaft with the second shaft hole. The wall of the second shaft hole has a second section intersection. The outer circumferential surface of the second transmission end of the output transmission shaft has a first section intersection, so that the first and the second section intersections are able to abut each other, so that the second clutch member can rotate with the output transmission shaft.

Preferably, the second transmission end of the output transmission shaft has a locking ring slot and a locking ring is provided in the locking ring slot. The locking ring abuts against one side of the second clutch member facing the first clutch member to prevent the second clutch member from falling off.

Preferably, the shape of the input end of the input transmission shaft is hexagonal in order to connect with the chuck so that the input transmission shaft can be driven to be rotated by the electric tool with the aforementioned chuck.

The detailed structure, features, assembly or use of the overload protection mechanism for the winch provided by the present invention will be described in the detailed description of the following embodiments. However, those with ordinary knowledge in the field of the present invention should be able to understand that the detailed description and the specific embodiments listed in the implementation of the present invention are only for describing the present invention, and do not limit the scope of claims of the present invention.

### BRIEF DESCRIPTION OF THE DRAWINGS

FIG. 1 is a perspective view of a winch having an overload protection mechanism of the present invention.

FIG. 2 is a three-dimensional view of the overload protection mechanism of the present invention.

FIG. 3 is a three-dimensional exploded view of the overload protection mechanism of the present invention.

FIG. 4 is a cross-sectional view of the overload protection mechanism of the present invention.

FIG. 5 is the plane diagram of the overload protection mechanism of the present invention, which shows engagement of the first engaged part of the first clutch member and the second engaged part of the second clutch member.

FIG. 6 shows the first engaged part of the first clutch member and the first engaged part of the second clutch member being separated from the second engaged part of the second clutch member.

### DETAILED DESCRIPTION OF THE INVENTION

In the specification, including the following embodiments and claims, nouns involving directionality are based on the direction as shown in the figures. In the following embodiments and drawings, the same element numbers represent the same or similar elements or structural features.

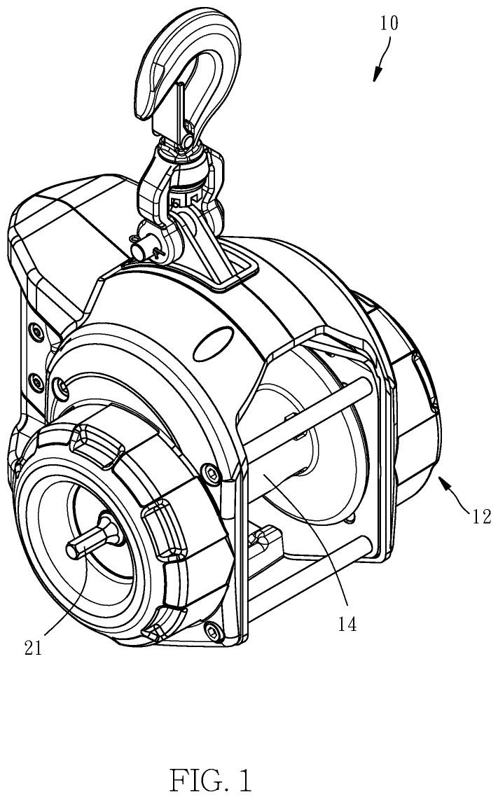

As shown in FIG. 1, the winch 10 contains an enclosure 12, a spool 14 and a reduction-gear set 16. The spool 14 is set in the enclosure in a rotatable manner. The reduction-gear set 16 is set in the enclosure 12 and connected to one end of the spool 14, so that the spool 14 can be driven by the reduction-gear set 16 to wind or release the rope, e.g., steel cable or rope (not shown in the figure).

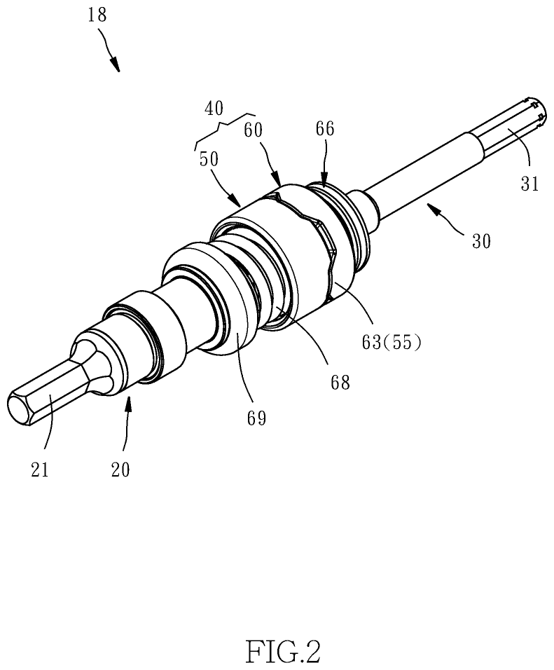

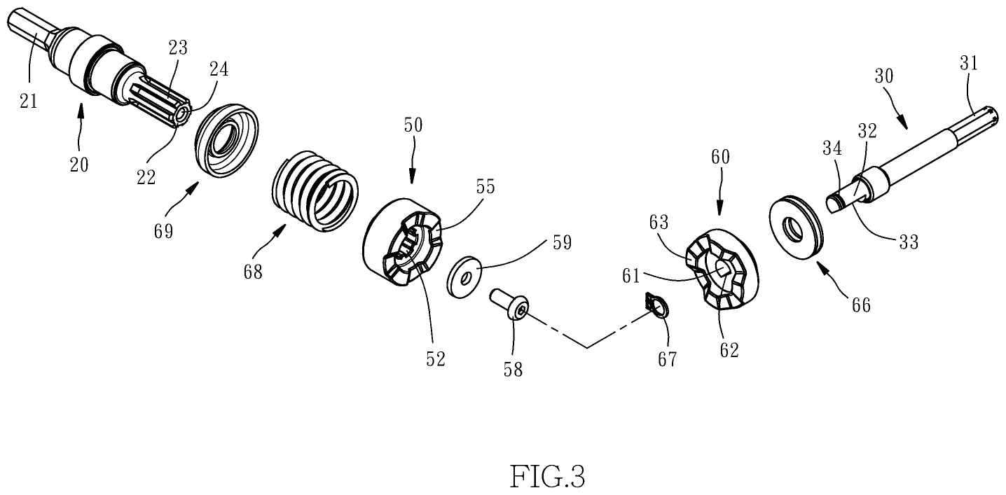

As seen in FIG. 2 and FIG. 3, the overload protection mechanism 18 of the present invention includes an input transmission shaft 20, an output transmission shaft 30, and a clutch mechanism 40.

The input transmission shaft 20 is rotatably arranged on the spool 14 and has an input end 21 and a first transmission end 22. The input end 21 is located outside the spool 14, and the input end 21 has a shape that is able to connect with the chuck (not shown in the figure) of an electric tool, e.g., having a hexagonal shape, and is configured so that the input transmission shaft 20 is able to be driven by the electric tool, e.g., to rotate. The first transmission end 22 is located in the spool 14. The outer circumferential surface of the first transmission end 22 has a plurality of elongated insertion portions 23 arranged in an equally spaced ring shape, and the first transmission end 22 has a screw hole 24 extending along its axial direction. In addition, the outer circumferential surface of the input transmission shaft 20 also has a shoulder 25 between the input end 21 and the first transmission end 22.

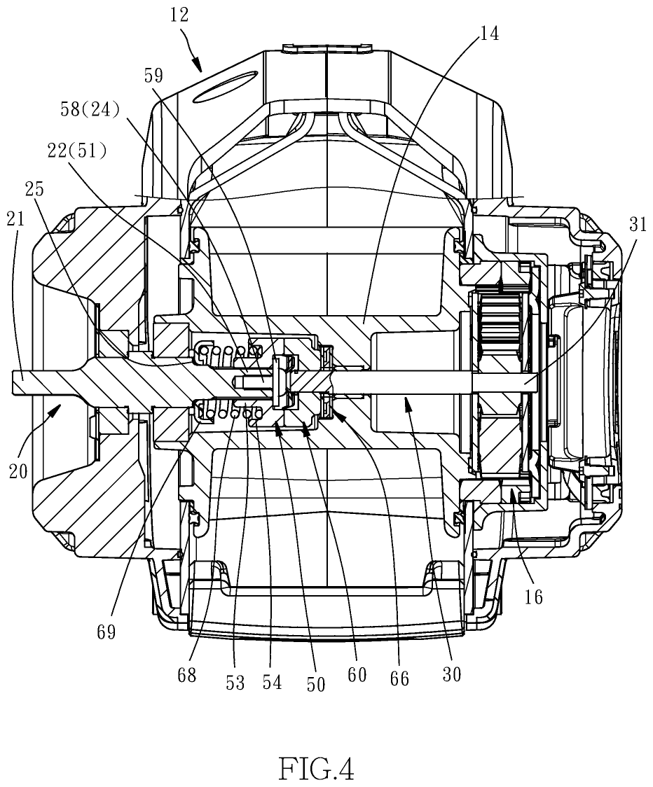

The output transmission shaft 30 is rotatably arranged on the spool 14 and is located on the same axis as the input transmission shaft 20. The output transmission shaft 30 has an output end 31 and a second transmission end 32. The output end 31 is located outside the spool 14 and is connected to the reduction-gear set 16 (as shown in FIG. 4), so that the output transmission shaft 30 is able to drive the reduction-gear set 16. The second transmission end 32 is located in the spool 14 and has a first section intersection 33. The outer circumferential surface of the second transmission end 32 also has a locking ring slot 34.

The clutch mechanism 40 has a first clutch member 50, a second clutch member 60 and an elastic part 68.

The first clutch member 50 has a first shaft hole 51 that penetrates the opposite sides of left and right sides of the first clutch member 50. The wall of the first shaft hole 51 has a plurality of elongated insertion slots 52 arranged in an equally spaced ring shape. The first clutch member 50 uses the first shaft hole 51 to be sleeved on the first transmission end 22 of the input transmission shaft 20, and then uses the insertion slots 52 to be embedded on the insertion portions 23 of the first transmission end 22 of the input transmission shaft 20, so that the first clutch member 50 is driven by the input transmission shaft 20 so that they rotate together. In addition, a screw 58 passes through a washer 59 and is locked in the screw hole 24 of the first transmission end 22 of the input transmission shaft 20, so that the washer 59 abuts against the right side of the first clutch member 50 and the end surface of the first transmission end 22 of the input transmission shaft 20 to prevent the first clutch member 50 from detaching from the first transmission end 22 of the input transmission shaft 20.

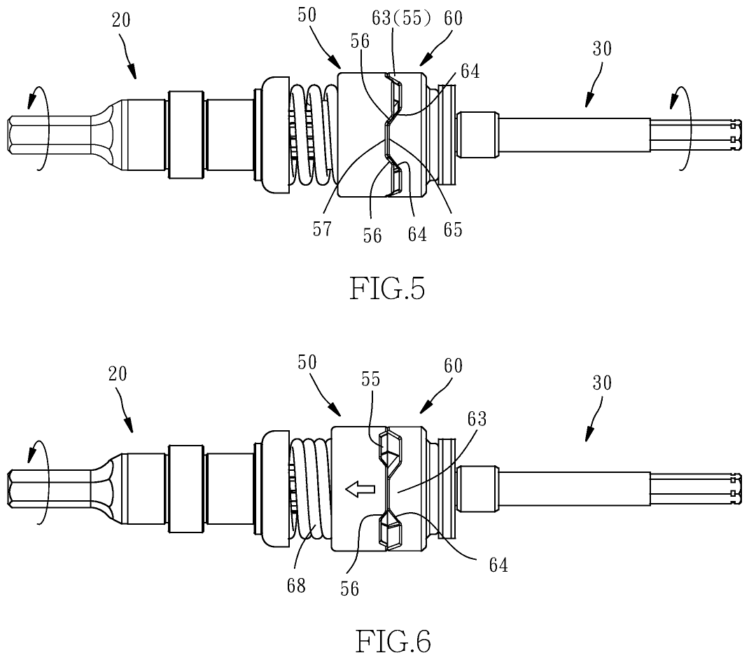

The second clutch member 60 has a second shaft hole 61 that penetrates the two opposite sides of the left and right sides of the second clutch member 60. The wall of the second shaft hole 61 has a second section intersection 62. The second clutch member 60 uses the second shaft hole 61 to be sleeved on the second transmission end 32 of the output transmission shaft 30, where its right side abuts against a thrust bearing 66 provided on the output transmission shaft 30, and then uses the second section intersection 62 to abut the first section intersection 33 of the second transmission end 32 of the output transmission shaft 30, so that the second clutch member 60 drives the output transmission shaft 30 so that they rotate together. In addition, a locking ring 67 is buckled into the locking ring slot 34 of the second transmission end 32 of the output transmission shaft 30 and abuts against the left side of the second clutch member 60 to prevent the second clutch member 60 from detaching from the second transmission end 32 of the output transmission shaft 30. As shown in FIG. 3 and FIG. 5, the edge of the left side of the second clutch member 60 has multiple second engaged parts 63. The second engaged parts 63 are arranged in a ring shape at equal intervals around the second shaft hole 61. Each second engaged part 63 is the other one of recesses or bumps. In this embodiment, at least one of the second engaged parts 63 is a bump that has two second inclined planes 64 with opposite inclination directions and one second plane 65 connecting the two second inclined planes 64. Therefore, as shown in FIG. 5, when the first engaged part 55 of the first clutch member 50 is engaged with the second engaged part 63 of the second clutch member 60, a first inclined plane 56 of the first engaged part 55 abuts the second inclined plane 64 of the second engaged part 63, and the first plane 57 of the first engaged part 55 abuts the second plane 65 of the second engaged part 63.

The elastic part 68, e.g., a compression spring here, is sleeved on the input transmission shaft 20. As shown in FIG. 3 and FIG. 4, one end of the elastic part 68 is located in a container 54 of the first clutch member 50, e.g., housing of the first clutch member 50, and is sleeved on a shaft 53 of the first clutch member 50, and abuts against the left side of the first clutch member 50. The other end of elastic part 68 is pressed against a support ring 69. The support ring 69 is sleeved on the input transmission shaft 20 and abuts against the shoulder 25 of the input transmission shaft 20 and is fixed therewith. In this way, the elastic part 68 can provide elastic force to push the first clutch member 50 toward the second clutch member 60.

It can be seen from the above that when the input transmission shaft 20 is driven by the electric tool, the first clutch member 50 rotate together with the input transmission shaft 20. As seen in FIG. 5, the first clutch member 50 uses the engaged relationship between its first engaged part 55 and the second engaged part 63 of the second clutch member 60 to drive the second clutch member 60 to rotate together. Then, the output transmission shaft 30 is driven by the second clutch member 60 to start the reduction-gear set 16, so that the reduction-gear set 16 will further drive the spool 14 to rotate, so as to achieve the effect of winding the rope.

When the rope is wound up, the output transmission shaft 30 will stop rotating with the spool 14 along with the second clutch member 60. If the electric tool continues to output power to the input transmission shaft 20 at this time, the input transmission shaft 20 will also drive the first clutch member 50 to rotate. However, if the first clutch member 50 starts to rotate, since the second clutch member 60 remains stationary, through the cooperation, e.g., engagement, of the first inclined plane 56 and the second inclined plane 64, on the one hand, the first clutch member 50 moves along the axial direction of the input transmission shaft 20 away from the second clutch member 60, which compresses the elastic part 68 to accumulate the elastic force of the elastic part 68, e.g., recovery power. On the other hand, the first clutch member 50 also rotates relative to the second clutch member 60, so that the first engaged part 55 of the first clutch member 50 gradually separates from the second engaged part 63 of the second clutch member 60. While the two are completely separated, the power transmission between the input transmission shaft 20 and the output transmission shaft 30 is cut off.

In summary, in terms of the present invention's overload protection mechanism 18 for a winch 10, under the condition that the output end 31 of the output transmission shaft 30 is under normal load, the first engaged part 55 of the first clutch member 50 and the second engaged part 63 of the second clutch member 60 are engaged with each other, so that the input transmission shaft 20 can transmit power to the output transmission shaft 30 through the clutch mechanism 40, so that the output transmission shaft 30 can rotate smoothly. Once the output end 31 of the output transmission shaft 30 is overloaded, the first engaged part 55 of the first clutch member 50 and the second engaged part 63 of the second clutch member 60 will be disengaged to cut off the power transmission between the input transmission shaft 20 and the output transmission shaft 30, so that the input transmission shaft 20 cannot transmit power to the output transmission shaft 30, and the overall structure is protected.

Description of the Symbols

| | |
|---|---|
| 10 Winch | 12 Enclosure |
| 14 Spool | 16 Reduction-Gear Set |
| 18 Overload Protection Mechanism | 20 Input Transmission Shaft |
| 21 Input End | 22 First Transmission End |
| 23 Insertion Portion | 24 Screw Hole |
| 25 Shoulder | 30 Output Transmission Shaft |
| 31 Output End | 32 Second Transmission End |
| 33 first section intersection | 34 Locking Ring Slot |
| 40 Clutch Mechanism | 50 First Clutch Member |
| 51 First Shaft Hole | 52 Insertion Slot |
| 53 Shaft | 54 Container |
| 55 First Engaged Part | 56 First Inclined Plane |
| 57 First Plane | 58 Screw |
| 59 Washer | 60 Second Clutch Member |
| 61 Second Shaft Hole | 62 Second Section Intersection |
| 63 Second Engaged Part | 64 Second Inclined Plane |
| 65 Second Plane | 66 Thrust Bearing |
| 67 Locking Ring | 68 Elastic Part |
| 69 Support Ring | |

1. An overload protection mechanism for a winch, comprising:
an input transmission shaft, which has an input end and a first transmission end;
an output transmission shaft, which coaxially corresponds to the input transmission shaft, and the output transmission shaft has a second transmission end and an output end; and
a clutch mechanism, said clutch mechanism comprising a first clutch member, a second clutch member and an elastic part, the first clutch member being located at the first transmission end of the input transmission shaft, so that the first clutch member is able to operate synchronously with the input transmission shaft, the second clutch member being located at the second transmission end of the output transmission shaft, so that the second clutch member is able to operate synchronously with the output transmission shaft,
wherein the first clutch member has a first engaged part, the second clutch member has a second engaged part, said first engaged part of the first clutch member being detachably engageable with the second engaged part of the second clutch member, and wherein the elastic part imparts an elastic force on the first clutch member to push the first clutch member toward the second clutch member.

2. The overload protection mechanism of claim 1, wherein the first engaged part of the first clutch member is one of recesses or bumps, and the second engaged part of the second clutch member is the other one of recesses or bumps.

3. The overload protection mechanism of claim 2, wherein the first engaged part of the first clutch member has two first inclined planes and a first plane connecting the two first inclined planes, wherein inclination directions of the two first inclined plane are in opposite directions,
wherein the second engaged part of the second clutch member has two second inclined planes and a second plane connecting the two second inclined planes, wherein inclination directions of the two second inclined planes are in opposite directions,
wherein when the first engaged part of the first clutch member is engaged with the second engaged part of the second clutch member, the first inclined plane of the first engaged part abuts on the second inclined plane of the second engaged part, and the first plane of the first engaged part abuts the second plane of the second engaged part.

4. The overload protection mechanism of claim 1, wherein an outer circumferential surface of the first transmission end of the input transmission shaft has an insertion portion, and the first clutch member has a first shaft hole, wherein the first shaft hole is sleeved on the first transmission end of the input transmission shaft, and a wall of the first shaft hole has an insertion slot, wherein the insertion slot engages with the insertion portion of the first transmission end of the input transmission shaft.

5. The overload protection mechanism of claim 1, wherein the first transmission end of the input transmission shaft has a screw hole, wherein the clutch mechanism further comprises a screw and a washer, wherein the screw passes through the washer and is screwed in the screw hole so that the washer abuts the first clutch member toward one side of the second clutch member and an end surface of the first transmission end of the input transmission shaft.

6. The overload protection mechanism of claim 1, wherein the elastic part is sleeved on the input transmission shaft, and an outer circumferential surface of the input transmission shaft has a shoulder between the input end and the first transmission shaft, and the clutch mechanism has a support ring, wherein one side of the support ring abuts the shoulder of the input transmission shaft, and the other opposite side of the support ring engages one end the elastic part, wherein the other end of the elastic part abuts against one side of the first clutch member facing the second clutch member.

7. The overload protection mechanism of claim 6, wherein the one side of the first clutch member opposite to the second clutch member has a shaft and a container surrounding the shaft, and one end of the elastic part is sleeved on the shaft and located in the container.

8. The overload protection mechanism of claim 1, wherein the second clutch member has a second shaft hole, and the second shaft hole is sleeved on the second transmission end of the output transmission shaft, and a wall of the second shaft hole has a second section intersection, where an outer circumferential surface of the second transmission end of the output transmission shaft has a first section intersection, and the first section intersection and the second section intersection are configured to engage with each other.

9. The overload protection mechanism of claim 1, wherein the second transmission end of the output transmission shaft has a locking ring slot, the locking ring slot is provided with a locking ring, and the locking ring abuts against the second clutch member toward one side of the first clutch member.

10. The overload protection mechanism of claim 1, wherein a shape of the input end of the input transmission shaft is hexagonal.
